(19) United States
(12) Patent Application Publication
(10) Pub. No.: US 2022/0098105 A1
(43) Pub. Date: Mar. 31, 2022

(54) DRY POLYMER MODIFIED CEMENT SURFACE COATING FOR ROOFING MATERIALS

(71) Applicant: W. Robert Wilson, Boonton, NJ (US)

(72) Inventor: W. Robert Wilson, Boonton, NJ (US)

(21) Appl. No.: 17/488,225

(22) Filed: Sep. 28, 2021

Related U.S. Application Data
(60) Provisional application No. 63/084,526, filed on Sep. 28, 2020.

(51) Int. Cl. C04B 28/04; C04B 40/00; E04D 7/00; C04B 20/00; C04B 20/10; C04B 24/26

(52) U.S. Cl. CPC C04B 28/04; C04B 40/0046; E04D 7/005; C04B 2111/27; C04B 20/1092; C04B 24/2623; C04B 20/006

(57) ABSTRACT

Roofing substrates, including shingles, provide for protection of the structure it is covering as well as aesthetics. Shingles come in various types including asphalt, clay, and metal. The shingles may have a dry polymer modified cement mixture applied on top of current shingles or may be used to replace certain layers of, for example, asphalt shingles. The dry polymer modified cement may be applied before or after installation. The dry polymer modified cement may be colored to provide desired aesthetics and lower absorption of the sun's radiation (e.g., visible spectrum, infrared spectrum). The dry polymer modified cement may add minimum weight to the shingles while providing protection to the underlying substrate from environmental deterioration and weathering, thus increasing life of the shingle. The dry polymer modified cement mixture is prepared by mixing a dry polymer modified cement blend (ordinary Portland cement, aggregate and polymer powders) with water.

### BACKGROUND

Roofs are often covered with shingles for protection and aesthetics. Shingles come in various types including asphalt, clay, and metal. The various shingles may be suspectable to environmental deterioration and weathering that effect the longevity of the shingles. Furthermore, if the shingles are to be utilized to assist in reducing energy costs, the shingles are typically colored to reflect sunlight and reduce heat (e.g., lighter colors, white) in warmer climates or absorb sunlight and maintain heat (e.g., darker colors, black) in cooler climates. In locations where there are large temperature swings between the seasons, such coloring only provides a benefit for one of the seasons (e.g., warm or cold).

FIG. 1 illustrates the most common type of asphalt shingle 100. The asphalt shingle 100 includes a first asphalt layer 110, a fiberglass mat 120, a second asphalt layer 130 and an aggregate coating 140. The first asphalt layer 110 acts as a binder layer and holds the shingle 100 together. The first asphalt layer 110 also abuts the roof. The fiberglass mat 120 is provided on top of the first asphalt layer 110 to provide stiffness irrespective of the temperature. When it is hot, the first and second asphalt layers 110, 130 will get soft, and the fiberglass mat 120 helps stiffen the asphalt layers 110, 130. The second asphalt layer 130 is applied to the fiberglass mat 120 and provides the durability and long-term performance of the shingle 100. The second asphalt layer 130 is also used to retain the aggregate 140 that is applied thereto. The second asphalt layer 130 is thicker than the first asphalt layer 110 and may include amendments that make the asphalt rubber like. The aggregate 140 is utilized to provide the desired color and texture to the shingle 100. The aggregate 140 is also used to protect the second asphalt layer 130 from, for example, ultra-violet light and precipitation (e.g., rain, snow).

Metal and clay tiles typically don't include aggregate to provide color or texture or to protect the shingle. Rather, clay shingles may be made the desired color by including the desired pigments in the clay the shingles are formed from. This requires that enough pigment to utilized to color the entire shingle which may be cost prohibitive. Metal or clay tiles may have coatings, such as, paints, thermoplastics, or polymer coatings (e.g., epoxy) applied thereto to provide the desired color. The various coatings may, for example, be worn off or lose their color over time. The coatings and the shingles may, for example, be susceptible to ultra-violet light and condensation (e.g., snow, rain).

What is needed is a means for providing a coating to the shingles that provides the desired color and texture, protects the shingles from environmental deterioration and weathering in order to increase the longevity of the shingles and assist in reducing energy consumption (costs).

### BRIEF DESCRIPTION OF THE DRAWINGS

The features and advantages of the various embodiments will become apparent from the following detailed description in which:

FIG. 1 illustrates an example of the most common type of asphalt shingle; and

FIGS. 2A-E illustrate various example asphalt shingles having the dry polymer modified cement mixture applied thereto, according to various embodiments.

### DETAILED DESCRIPTION

Polymer modified cements are cement blends (e.g., concrete, mortar) that include the addition of the polymers to, for example, increase flexibility, increase workability, increase bond with underlying substrate and/or form a tough and long-wearing surface. Preferred polymer modified cements used as surface coatings have excellent initial and long-term bond to roofing substrates. Preferred polymer modified cements do not soften at elevated temperatures or embrittle at lower temperatures. Preferred polymer modified cements may also act as an adhesive layer (similar to epoxy, polyurethane, and bitumen) where prior to curing aggregate may be received thereby and then once cured the aggregate may be secured therein. Preferred polymer modified cements provide a surface coating that is resistant to weathering (e.g., ultraviolet light, snow, rain, varying temperatures) and has a long-life expectancy. The polymer modified cements may include pigments for coloring.

Preferred polymer modified cements may be designed to be applied to different roofing and/or shingle substrates (asphalt, clay, metal, concrete) as surface coatings. The preferred polymer modified cements may be used to form a flexible thin layer on the roofing substrates (asphalt, clay, concrete, metal). The polymer modified cement may be provided on top of current shingles or may be used to replace certain layers of, for example, asphalt shingles. The polymer modified cement may be colored to provide the desired aesthetics and function. According to one embodiment, the polymer modified cement may be capable of having aggregate embedded therein to provide texture to the shingles and/or provide a desired aesthetic. The polymer modified cement may add minimum weight to the shingles while providing protection to the underlying shingle substrate from environmental deterioration and weathering, thus increasing the life of the shingle. The polymer modified cement may lower the absorption of the sun's radiation (e.g., visible spectrum, infrared spectrum) and thus lower a buildings energy consumption.

Cement blends typically include cement (e.g., ordinary Portland cement), aggregate and possibly other materials (e.g., microfibers, plasticizer, filler, accelerator, retarder). The polymers used in the polymer modified cements may be, for example, dry polymers (e.g., polymer powders). The dry polymers may be mixed with the cement blend to create a dry polymer modified cement blend. The dry polymer modified cement blend is mixed with water to create a dry polymer modified cement mixture that is applied to the desired location. The use of a dry polymer improves the quality control during the mixing of the product as the dry polymer modified cement blend may simply require the addition of water which simplifies the mixing operation. The dry polymer modified cements will not typically have some of the issues associated with wet polymer modified cements (e.g., air voids, surface tension cracks).

The dry polymers may be redispersible binders. According to one embodiment, the redispersible binders may be based on a copolymer of vinyl acetate and ethylene. The redispersible polymer may also include defoaming and self-leveling properties to assist with the reduction of air during the mixing process that is common when wet polymers are mixed with cement blends. The reduction of air improves the impermeability of the surface mix and increases the abrasion resistance of the cured material.

The aggregate typically used in cement blends, as well as dry polymer modified cement blends, is sand or other aggregate having gradations that meet the ASTM C144 specification. The aggregate is used to provide layer thickness, to improve mixing, limit segregation and may provide a rough surface that can increase skid resistance. Using aggregate gradations that meet the ASTM C144 specification provides a gradation that is intended to consume a moderate quantity of cement, produces a wet mix that is workable without having to use too much water or additives, does not shrink excessively, and cures at an appropriate rate to allow a bond to develop with the underlying substrate. Using aggregate gradations that meet the ASTM C144 specification produces, after mixing the blend with water, a dry polymer modified cement mixture that may be applied to an underlying roofing as a relatively thin layer (e.g., thickness of up to approximately ⅛ in (3 mm).

It was believed that aggregate having a finer gradation than ASTM C144 specification would consume too much cement. However, using aggregate with finer gradations than the ASTM C144 specification (ultrafine aggregate) actually provides a dry polymer modified cement mixture that can be applied even thinner (and thus not consume additional cement) and also enables objects (e.g., topical aggregate) to be received thereby easier and be secured therein better. The ultrafine aggregate may be any semi gap graded material with a D₈₀ of less than 300 microns and a D₄₀ of less than 200 microns. According to one embodiment, the ultrafine aggregate may be marble dust. A dry polymer modified cement mixture using ultrafine aggregate may be applied to an underlying roofing substate at thicknesses between 1/75^{th} inch (0.3 mm) to 1/16^{th} inch (1.5 mm).

According to one embodiment, the dry polymer modified cement mixture may also include microfibers to limit segregation, shrinkage and exothermal generation and improve workability. The microfibers may be natural or synthetic. The microfibers may have a length of up to approximately 1 inch.

According to one embodiment, the dry polymer modified cement mixture may also include additives. The additives may include, for example, a plasticizer to increase workability. The additives may include a filler, such as a pozzolanic filler, to increase workability, limit segregation and shrinkage and increase long term compressive strength. The filler may be fly ash, such as class C or class F fly ash. The additives may include, for example, an accelerator to increase curing process that may be needed for night time applications and time sensitive applications. The additives may include, for example, a retarder along with the accelerator to delay the change in workability that comes from adding the accelerator.

According to one embodiment, the dry polymer modified cement mixture may be the same or similar to the dry polymer cement overlay described in U.S. Pat. No. 8,784,557 which is herein incorporated by reference. According to one embodiment, the dry polymer cement may use different versions for at least some of the various ingredients described therein (e.g., may use different dry polymers than the Elotex® polymers noted therein, aggregate may be ultrafine aggregate), may use different ratios for at least some of the ingredients, may replace certain ingredients, may add ingredients thereto, may delete ingredients therefrom, may use a single ingredient in place of a combination of different ingredients and/or may use a combination of different ingredients instead of a single ingredient. The ingredients and the ratios may depend on the specific application of the dry polymer cement overlay.

According to one embodiment, the dry polymer modified cement may be the Endurablend® or Enduramark® products provided by Pavement Surface Coatings, LLC, a New Jersey Corporation.

Within the dry polymer modified cement blend, the base color of the cement is a light color (e.g., white) and the base color of the aggregate (e.g., marble dust) may also be a light color (e.g., white). Accordingly, the starting color of the dry polymer modified cement mixture is a light color. Furthermore, the base colors of the cement and aggregate do not fade so the light color should not fade or wear over time. As such, base dry polymer modified cement (e.g., without any pigment added thereto) applied to different roofing and/or shingle substrates (asphalt, clay, metal, concrete) may provide a shingle having a light color that is maintained better than a light colored aggregate applied to asphalt shingles or light colored paints, thermoplastics, or polymer coatings (e.g., epoxy) that may currently be applied to metal or clay shingles or directly to a concrete roof.

The dry polymer modified cement may include a white pigment to make the dry polymer modified cement visibly whiter and brighter. Using a white pigmented dry polymer modified cement for a roofing color may reflect additional solar radiation (in the visible light spectrum) and thus provide cooling for roofs in warmer climates. White color roofing may be desirable for an office building or the like that have flat roofs that are not readily visible from the ground. However, a white roof may not be desirable in many situations such as residential housing that typically includes a pitched roof that is readily visible from the ground. The white color may be too bright and may also be susceptible to discoloration caused by dirt or the like being easily visible.

The dry polymer modified cement mixture may include pigments to provide an appropriate color for the desired use or aesthetic of the roof. For example, the dry polymer modified cement may be pigmented to the color desired for the roofing. As the thin overlay is colored throughout, the color retention of the dry polymer modified cement is excellent. Furthermore, as the dry polymer modified cement mixture may be applied as a thin layer the amount of pigment required is reduced. Accordingly, it is possible to use pigments that provide vibrant darker colors that also limit the absorption of infrared light. That is, pigments may be provided that limit the absorption of infrared light that are not the lighter colors normally associated with reflecting visible light. As such, the use of colored pigments may provide the ability to reduce energy consumption/costs.

The dry polymer modified cement blend may be delivered to the site with all the necessary elements mixed together at the appropriate proportions for the job at hand. The dry polymer modified cement mixture may be prepared by mixing an appropriate amount of dry polymer modified cement blend with an appropriate amount of water. According to one embodiment, the dry polymer modified cement blend may be mixed with cold water or ice may be added with the water to increase the workability of the mixture.

The dry polymer modified cement mixture may be applied to the shingles at the factory prior to sending to the location they will be installed on. Alternatively, the dry polymer modified cement mixture may be applied to the shingles at the location, either prior to installation or after installation. The dry polymer modified cement mixture may be applied to the shingle substrates by, for example, brushing, dipping or spraying. As the dry polymer modified cement mixture is to be applied as a thin overlay the mixture may be preferably sprayed on. The dry polymer modified cement mixture is applied wet to the shingle substrate so that it ensures an excellent initial and long-term bond.

The dry polymer modified cement mixture may be prepared and provided to some type of device that enables it to be sprayed onto the shingles. The type of device depends on, for example, whether the dry polymer modified mixture is applied at the factory or at the location. The device may include one or more nozzles that can be activated to spray the dry polymer modified cement mixture onto the shingles. If the shingles are to include aggregate, the aggregate may be provided (e.g., dropped, broadcast, blown) onto the dry polymer modified cement mixture before the mixture cures. The aggregate may be provided to some type of device that provides the aggregate onto the shingles. The type of device depends on for example, where and how the aggregate is provided. According to one embodiment, if the dry polymer modified cement mixture is applied at the factory, a machine may be utilized that passes the shingles under the nozzles where the dry polymer modified mixture is applied and then under, for example, a dispenser where the aggregate is applied before the mixture has time to cure.

The dry polymer modified cement mixture may be applied on various roofing shingles. For example, the dry polymer modified cement mixture may be applied to asphalt shingles, clay shingles or metal shingles. The modified dry polymer modified cement mixture may be applied directly to the shingle in the case of clay and/or metal shingles. If desired, aggregate may be applied on top of the modified dry polymer modified cement mixture.

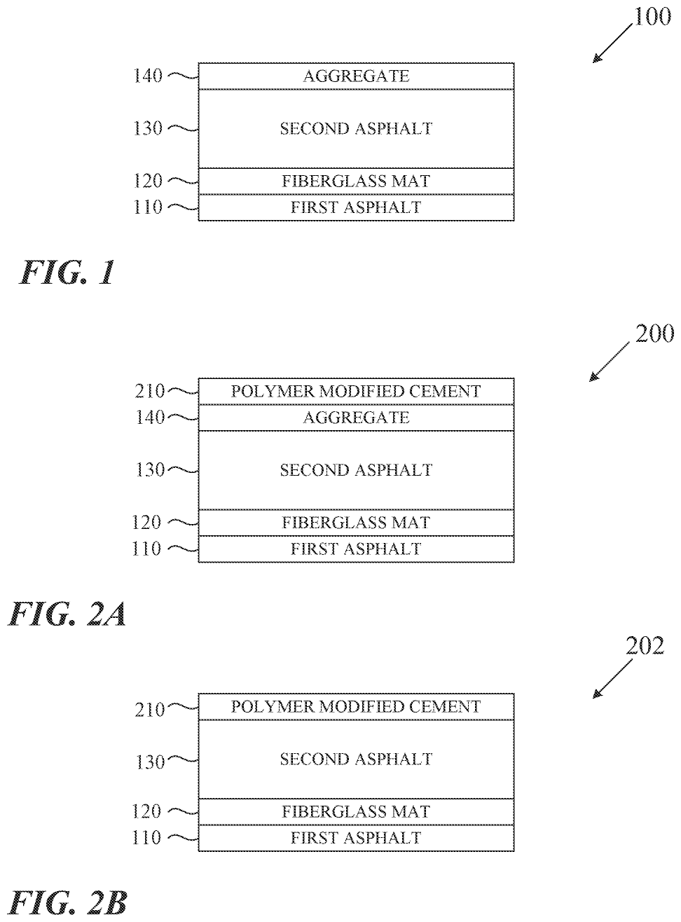

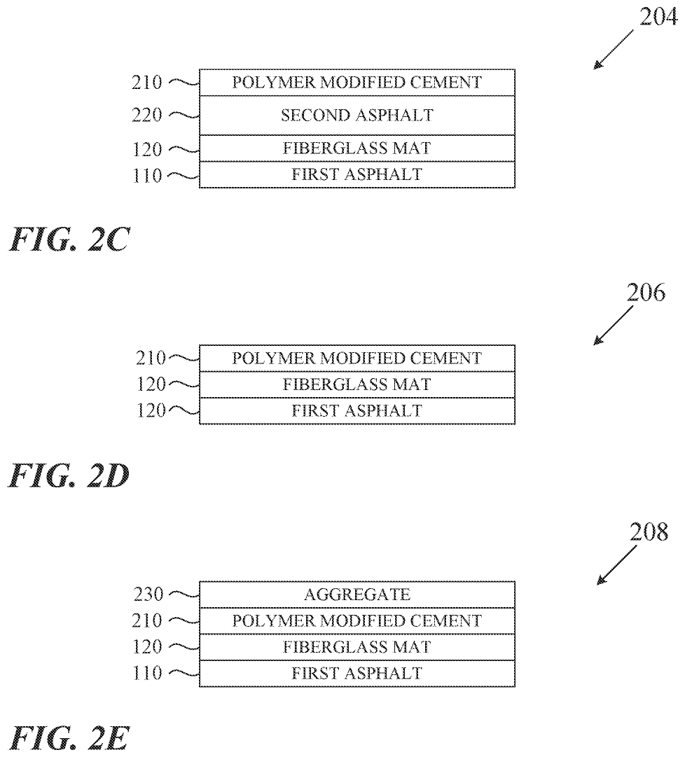

FIGS. 2A-E illustrate various example asphalt shingles having the dry polymer modified cement mixture applied thereto. FIG. 2A illustrates an example modified asphalt shingle 200 where a dry polymer modified cement mixture 210 is applied on top of the aggregate layer 140 of the most common type of asphalt shingle (previously illustrated in FIG. 1).

The modified asphalt shingle 200 may be produced by applying the dry polymer modified cement mixture on top of current shingles in the field either before or after the shingles are installed. In fact, the modified dry polymer modified cement mixture could be applied to shingles that have been installed for some type to help preserve the previously installed shingles.

Alternatively, the use of the modified dry polymer modified cement mixture on asphalt shingles may result in modifying the asphalt shingles based on the inclusion of the modified dry polymer modified cement mixture.

FIG. 2B illustrates an example modified asphalt shingle 202 where the dry polymer modified cement mixture 210 provides the color and protection for the underlying asphalt and is accordingly applied directly on the second asphalt layer 130. In this embodiment, the aggregate 140 is not included.

FIG. 2C illustrates an example modified asphalt shingle 204 where the dry polymer modified cement mixture 210 may also provide durability and increase the long-term performance of the shingle, so that a thinner second asphalt layer 220 is utilized. In addition, the second asphalt layer may have the amendments that make the asphalt rubber like reduced or eliminated. FIG. 2D illustrates an example modified asphalt shingle 206 where the second asphalt layer may be eliminated altogether.

FIG. 2E illustrates an example modified asphalt shingle 206 where aggregate 230 is provided on top of the dry polymer modified cement mixture 210 to provide texture thereto. The aggregate may be added to the dry polymer modified cement mixture prior to it curing.

The dry polymer modified cement mixture may be applied on flat, smooth, textured or corrugated surfaces. The dry polymer modified cement mixture adds minimal weight to the roofing substrate so should not require additional structural support for the roof where they are to be applied. Furthermore, as the dry polymer modified cement mixture is applied as a thin surface coating it will not substantially increase the footprint (dimensions) of the roofing substrate. As such, the shingles with the dry polymer modified cement surface coating should not reduce the number of shingles that are packaged together or significantly increase freight costs. In fact, the various embodiments of the asphalt shingle described in FIGS. 2C-2E may have smaller footprints and weigh less that the common asphalt shingle of FIG. 1.

The dry polymer modified cement surface coating may provide additional hail and wind protection to the roofing materials. The dry polymer modified cement surface coating provides thermal protection by reducing the long IR wavelengths from heating the buildings and will accordingly lower energy consumption. The dry polymer modified cement surface coating will reduce thermal swings that result in weathering to the roofing materials. The dry polymer modified cement surface coating has excellent initial and long-term bonding to the underlying roofing substrate. While the dry polymer modified cement surface coating may be pigmented to provide the desired aesthetics, including very vibrant colors provided by high end pigments, it may still provide the infrared absorption performance. The dry polymer modified cement surface coating is fully recyclable.

Although the invention has been illustrated by reference to specific embodiments, it will be apparent that the invention is not limited thereto as various changes and modifications may be made thereto without departing from the scope. Reference to “one embodiment” or “an embodiment” means that a particular feature, structure or characteristic described therein is included in at least one embodiment. Thus, the appearances of the phrase “in one embodiment” or “in an embodiment” appearing in various places throughout the specification are not necessarily all referring to the same embodiment.

The various embodiments are intended to be protected broadly within the spirit and scope of the appended claims.

1. A method for protecting a roofing substrate from environmental deterioration and weathering, the method comprising:
preparing a dry polymer modified cement mixture by mixing a dry polymer modified cement blend with water, wherein the dry polymer modified cement blend includes ordinary Portland cement, aggregate and polymer powders; and
applying the dry polymer modified cement mixture as a surface coating on the roofing substrate, wherein the surface coating is applied as a thin layer.

2. The method of claim 1, wherein the polymer powders are redispersible binders based on a copolymer of vinyl acetate and ethylene.

3. The method of claim 1, wherein the aggregate is a semi gap graded material with a D₈₀ of less than 300 microns and a D₄₀ of less than 200 microns.

4. The method of claim 1, wherein the dry polymer modified cement blend further includes microfibers to limit segregation, shrinkage and exothermal generation and improve workability.

5. The method of claim 1, wherein the dry polymer modified cement blend includes pigments to provide a desired color for the roofing substrate.

6. The method of claim 5, wherein the pigments may be selected to reflect infrared radiation.

7. The method of claim 1, wherein the applying a dry polymer modified cement mixture includes applying the dry polymer modified cement mixture at thicknesses between 1/75^{th} inch (0.3 mm) to 1/16^{th} inch (1.5 mm).

8. The method of claim 1, wherein the applying a dry polymer modified cement mixture includes spraying the dry polymer modified cement mixture onto the roofing substrate.

9. The method of claim 8, wherein the dry polymer modified cement mixture is sprayed onto the roofing substrate prior to installation.

10. The method of claim 8, wherein the dry polymer modified cement mixture is sprayed onto the roofing substrate after installation.

11. The method of claim 8, wherein the dry polymer modified cement mixture is sprayed onto an existing roofing substrate.

12. The method of claim 1, further comprising providing topical aggregate onto the applied dry polymer modified cement mixture.

13. The method of claim 1, wherein the roofing substrate is selected from a clay shingle, a metal shingle, an asphalt shingle and a concrete roof.

14. A roofing shingle comprising:
a roofing substrate; and
a dry polymer modified cement mixture applied on top of the roofing substrate to protect the roofing substrate from environmental deterioration and weathering, wherein the dry polymer modified cement mixture includes a dry polymer modified cement blend mixed with water, wherein the dry polymer modified cement blend includes ordinary Portland cement, a semi gap graded aggregate with a D₈₀ of less than 300 microns and a D₄₀ of less than 200 microns, and redispersible binders polymer powders.

15. The shingle of claim 14, wherein the dry polymer modified cement blend further includes pigments to provide an appropriate color and reflective index for the roofing substrate.

16. The shingle of claim 14, further comprising topical aggregate on the dry polymer modified cement mixture.

17. The shingle of claim 14, wherein the roofing substrate is selected from a clay shingle, a metal shingle, and an asphalt shingle.

18. The shingle of claim 14, wherein the roofing substrate is an asphalt shingle the roofing substrate is an asphalt shingle having a first asphalt layer, a fiberglass mat and a second asphalt layer and the dry polymer modified cement mixture is applied on the second asphalt layer.

19. The shingle of claim 14, wherein the roofing substrate is an asphalt shingle having a first asphalt later and a fiberglass mat and the dry polymer modified cement mixture is applied on the fiberglass mat.

20. The shingle of claim 14, wherein the dry polymer modified cement mixture is capable of being applied to the roofing substrate prior to installation or after installation.
